(19) United States
(12) Patent Application Publication
(10) Pub. No.: US 2025/0120446 A1
(43) Pub. Date: Apr. 17, 2025

(54) AEROSOL GENERATION DEVICE

(71) Applicant: Japan Tobacco Inc., Tokyo (JP)

(72) Inventor: Nobuhiro TATSUTA, Tokyo (JP)

(73) Assignee: Japan Tobacco Inc., Tokyo (JP)

(21) Appl. No.: 18/991,751

(22) Filed: Dec. 23, 2024

Related U.S. Application Data
(63) Continuation of application No. PCT/JP2022/025827, filed on Jun. 28, 2022.

(51) Int. Cl. A24F 40/51; A24F 40/20; A24F 40/465; A24F 40/485; A24F 40/70

(52) U.S. Cl. CPC A24F 40/51; A24F 40/465; A24F 40/485; A24F 40/70; A24F 40/20

(57) ABSTRACT

An aerosol generation device including an accommodation space that accommodates an aerosol-generating base material, a heat-insulating structural body that has a cylindrical structure and that faces the accommodation space at an inner-side surface of the cylindrical structure, a heat-generating part that is provided to part of the inner-side surface of the heat-insulating structural body, and a temperature detection unit that is provided inside the heat-insulating structural body in correspondence to the heat-generating part.

### CROSS-REFERENCE TO RELATED APPLICATION

This application is a Continuation of PCT International Application No. PCT/JP2022/025827, filed on Jun. 28, 2022, which is hereby expressly incorporated by reference into the present application.

### TECHNICAL FIELD

The present invention relates to an aerosol generation device.

### BACKGROUND ART

An inhaler device such as electronic tobacco or a nebulizer generating a substance to be inhaled by a user is widely used. The inhaler device can generate an aerosol by heating an aerosol source. Thus, the user can taste a flavor of the aerosol when the user inhales aerosol generated by the inhaler device.

For example, the inhaler device can generate the aerosol from an aerosol source material including the aerosol source by heating the aerosol source material from an outer circumference. However, when the aerosol source material is heated from the outer circumference, heat used for heating is transferred to a housing of the inhaler device and transmitted to the hand of the user who holds the inhaler device. This may cause the user to feel uncomfortable. Accordingly, it is important for the inhaler device heated from the outer circumference to have a heat insulation structure that suppresses heat transfer to the housing.

For example, Patent Literature 1 described below discloses a device for heating a smoking material that suppresses heat transfer to a housing with a heat insulation region surrounding a heating zone.

### CITATION LIST

### Patent Literature

Patent Literature 1: JP 2020532977 A

### SUMMARY OF INVENTION

### Technical Problem

However, with the device disclosed in Patent Literature 1 above, the heating zone to heat the aerosol source material is covered with the heat insulation region. Thus, it is difficult to directly measure the temperature of the heating zone. Accordingly, with the device disclosed in Patent Literature 1, it is difficult to measure the temperature of the heating zone with high accuracy.

Accordingly, the present invention has been made in view of the above-described problem and is aimed at providing a new improved aerosol generation device that can measure the temperature of a heater with higher accuracy.

### Solution to Problem

In order to solve the above-described problem, according to an aspect of the present invention, an aerosol generation device is provided. This aerosol generation device includes an accommodation space to accommodate an aerosol source material, a heat insulation structure that has a tubular structure and faces the accommodation space at an inner side surface of the tubular structure thereof, a heater provided in part of the inner side surface of the heat insulation structure, and a temperature detector provided in the heat insulation structure so as to correspond to the heater.

The heater may produce heat through induction heating caused by a varying magnetic field, and the temperature detector may be provided so as to correspond to an electromagnetic induction source generating the varying magnetic field.

The heat insulation structure may include a first member that faces the accommodation space and a second member that covers an outer side surface of the first member and forms a sealed space between the first member and the second member.

A material of the first member and a material of the second member may be different from each other.

The first member and the second member may be joined to each other by brazing.

The temperature detector may be provided in the sealed space of the heat insulation structure.

An inside of the sealed space may be in a vacuum state.

A part of the first member may produce heat through the induction heating so as to function as the heater.

The temperature detector may be secured, with a thermosetting adhesive, to the first member functioning as the heater.

The temperature detector may detect a temperature of the heater.

The temperature detector may include a thermocouple.

An air flow conveying an aerosol generated from the aerosol source material may flow through the accommodation space, and a heat-resistant cable that extends to an upstream side of the air flow so as to be led to an outside of the heat insulation structure may be connected to the thermocouple.

### Advantageous Effects of Invention

As has been described, according to the present invention, the temperature of the heater can be measured with higher accuracy.

### BRIEF DESCRIPTION OF DRAWINGS

FIG. 1 is a schematic view illustrating a configuration example of an inhaler device according to an embodiment of the present invention.

FIG. 2 is a schematic sectional view illustrating a configuration of a holder included in the inhaler device.

FIG. 3 is a schematic sectional view illustrating a configuration of a holder according to a modification.

### DESCRIPTION OF EMBODIMENTS

A preferred embodiment of the present invention will be described in detail below with reference to the accompanying drawings. In the present description and the drawings, structural elements having substantially the same functional configurations are denoted by the same reference numerals, thereby to omit redundant description.

### (1) Configuration of Inhaler Device

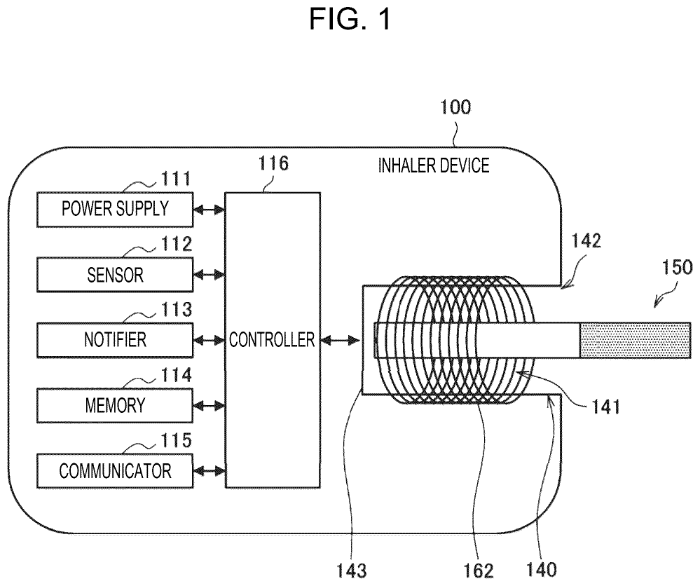

First, a configuration example of an inhaler device according to an embodiment of the present invention is described with reference to FIG. 1. FIG. 1 is a schematic view illustrating a configuration example of an inhaler device 100 according to the present embodiment.

As illustrated in FIG. 1, the inhaler device 100 includes, for example, a power supply 111, a sensor 112, a notifier 113, a memory 114, a communicator 115, a controller 116, an electromagnetic induction source 162, and a holder 140.

The inhaler device 100 according to the present embodiment heats a stick substrate 150 including an aerosol source through induction heating (IH) while holding the stick substrate 150 at the holder 140. Thus, when the aerosol source included in the stick substrate 150 is atomized, an aerosol is generated from the stick substrate 150. The generated aerosol is inhaled by a user.

The inhaler device 100 and the stick substrate 150 cooperate to generate the aerosol to be inhaled by the user. Accordingly, a combination of the inhaler device 100 and the stick substrate 150 may be understood as an aerosol generation system.

The power supply 111 stores electric power and supplies the electric power to the structural elements of the inhaler device 100. The power supply 111 may be, for example, a rechargeable/dischargeable secondary battery such as a lithium-ion secondary battery. The power supply 111 may be recharged by being connected to an external power supply through a universal serial bus (USB) cable or the like. Furthermore, the power supply 111 may be connected to be recharged by using a wireless power transmission technology with a power transmission device not directly connected to the power supply 111. Furthermore, the power supply 111 may be detachably attached to the inhaler device 100 and replaceable with a new power supply 111.

The sensor 112 detects various items of information on the inhaler device 100 and outputs the detected information to the controller 116. In an example, the sensor 112 may be a pressure sensor such as a condenser microphone, a flow sensor, or a temperature sensor. In such a case, the sensor 112 can output information indicating that user's inhalation is performed to the controller 116 when the sensor 112 detects a value generated in accordance with the user's inhalation. In another example, the sensor 112 may be an input device such as a button or a switch that receives information input by the user and may include, for example, a button that instructs to start/stop generation of the aerosol. In such a case, the sensor 112 can output the information input by the user to the controller 116. In another example, the sensor 112 may be a temperature sensor that detects the temperature of a heater that heats the stick substrate 150. The temperature sensor may detect the temperature of the heater based on, for example, an electric resistance of the electromagnetic induction source 162. In such a case, the sensor 112 can detect the temperature of the stick substrate 150 held by the holder 140 based on the temperature of the heater.

The notifier 113 provides information to the user. In an example, the notifier 113 may be a light-emitting device such as a light-emitting diode (LED). This allows the notifier 113 to emit light in different patterns of light respectively for different cases where the power supply 111 needs to be recharged, where the power supply 111 is being recharged, where an abnormality occurs in the inhaler device 100, and the like. The patterns of light here are a concept including the color, timing of turning on/off, and the like. The notifier 113 may be, in addition to the light-emitting device or instead of the light-emitting device, a display device that displays an image, a sound output device that outputs sound, a vibration device that vibrates, or the like. In addition, the notifier 113 may provide information indicating that inhalation by the user is enabled. The information indicating that the inhalation by the user is enabled is provided to the user when, for example, the temperature of the stick substrate 150 heated through the induction heating has reached a predetermined temperature.

The memory 114 stores various items of information for operation of the inhaler device 100. The memory 114 may be a non-volatile storage medium such as flash memory. An example of the information stored in the memory 114 is information related to an operating system (OS) of the inhaler device 100 such as the details of control of the various structural elements to be performed by the controller 116. Another example of the information stored in the memory 114 is information related to inhalation by the user such as the number of times of inhalation, inhalation time, or an accumulated inhalation time period.

The communicator 115 is a communication interface for transmission and reception of information between the inhaler device 100 and another device. The communicator 115 can perform communication in conformity with any wired or wireless communication standard. Such a communication standard may be, for example, a wireless local area network (LAN), a wired LAN, Wi-Fi (registered trademark), Bluetooth (registered trademark), or the like. In an example, the communicator 115 may transmit the information related to the inhalation by the user to a smartphone so as to display the information related to the inhalation by the user on the smartphone. In another example, the communicator 115 may receive new OS information from the server so as to update the OS information having been stored in the memory 114.

The controller 116 functions as an arithmetic processing unit and a control device and controls the overall operations of the inhaler device 100 in accordance with various programs. The controller 116 may be implemented, for example, in an electronic circuit such as a central processing unit (CPU) or a microprocessor. Furthermore, the controller 116 may include a read-only memory (ROM) that stores programs, operating parameters, and the like to be used and a random-access memory (RAM) that temporarily stores appropriately varying parameters and the like.

Specifically, the controller 116 may control execution of various processes related to the operation of the inhaler device 100. For example, the controller 116 may control the execution of the following processes: supplying power from the power supply 111 to the structural elements; recharging of the power supply 111; detection of the information by the sensor 112; notification of information by the notifier 113; storing or reading of the information by the memory 114; transmission and reception of the information by the communicator 115; and the like. Furthermore, the controller 116 can control execution of processes and the like performed by the inhaler device 100 based on input of the information to the structural elements and information output from the structural elements.

The holder 140 has an accommodation space 141 and an opening 142 that allows the accommodation space 141 to communicate with the outside. The holder 140 holds the stick substrate 150 inserted into the accommodation space 141 through the opening 142. Specifically, the holder 140 may have a tubular shape in which the opening 142 and a bottom 143 serve as bottom surfaces and which defines the pillar-shaped accommodation space 141 with a side surface. An inner diameter of the holder 140 is smaller than an outer diameter of the stick substrate 150 in at least part of the holder 140 in the height direction of the tubular shape. Thus, the stick substrate 150 inserted into the accommodation space 141 can be pressed from an outer circumference and held. Furthermore, the holder 140 also has the function of defining a flow path of air passing through the stick substrate 150. For example, an air inlet hole that is an inlet of the air into the flow path is disposed, for example, in the bottom 143. The opening 142 serves as an air outlet hole that is an outlet of the air from the flow path.

Furthermore, a partial region of the holder 140 also serves as the heater. For example, when an inner wall of the holder 140 facing the accommodation space 141 is made of a material that produces heat due to electromagnetic induction from the electromagnetic induction source 162, the holder 140 can heat the stick substrate 150 through the induction heating from the electromagnetic induction source 162.

The stick substrate 150 is a stick member including the aerosol source. The aerosol source is atomized by being heated, thereby the aerosol is generated. For example, the aerosol source may be a product derived from tobacco, a product made by forming shredded tobacco or a tobacco raw material into a granule, a sheet, or powder, or the like. The aerosol source may include a component not derived from tobacco but generated from a plant (for example, mint, herb, or the like) other than tobacco. In an example, the aerosol source may include a flavor component. When the inhaler device 100 is a medical inhaler, the aerosol source may include a medicine to be inhaled by a patient. The aerosol source is not limited to a solid but may be a liquid such as, for example, a polyhydric alcohol such as glycerine or propylene glycol or water. A region of the stick substrate 150 where the aerosol source is included is accommodated in the accommodation space 141 of the holder 140 when the stick substrate 150 is held in the holder 140.

Furthermore, at least part of the stick substrate 150 protrudes from the opening 142 when the stick substrate 150 is held in the holder 140. When the user inhales while holding one end of the stick substrate 150 protruding from the opening 142 in his/her mouth, the air flows into the inside of the holder 140 through the air inlet hole (not illustrated). The air having flowed passes through the accommodation space 141 of the holder 140 and reaches, together with the aerosol generated from the stick substrate 150, the inside of the mouth of the user.

The electromagnetic induction source 162 is provided along an insertion direction of the stick substrate 150 further outside of the holder 140. When an alternating current is supplied from the power supply 111, the electromagnetic induction source 162 can generate a varying magnetic field at a position of the electromagnetic induction source 162 overlapping part of the holder 140. Thus, the electromagnetic induction source 162 can generate an eddy current due to electromagnetic induction in the holder 140 functioning as the heater, thereby to produce Joule heat in the holder 140. Furthermore, the electromagnetic induction source 162 can generate a hysteresis loss due to electromagnetic induction in the holder 140 functioning as the heater so as to cause the holder 140 to produce heat. The heat produced by the holder 140 heats the aerosol source included in the stick substrate 150 so as to generate the aerosol.

For example, when the sensor 112 detects that a predetermined user input is performed, the inhaler device 100 may supply the electric power to the electromagnetic induction source 162 so as to heat the aerosol source included in the stick substrate 150 through the induction heating, thereby to generated the aerosol. When the temperature of the aerosol source has reached a predetermined temperature, the inhaler device 100 permits the inhalation by the user. Then, when the sensor 112 detects that a predetermined user input is performed, the inhaler device 100 may stop the supply of the electric power to the electromagnetic induction source 162. Furthermore, for example, the inhaler device 100 may supply the electric power to the electromagnetic induction source 162 to generate the aerosol while performance of the inhalation by the user is kept detected by the sensor 112.

In the inhaler device 100 according to the present embodiment, the holder 140 also functions as a heat insulation element that suppresses transfer of the heat produced by the heater to a housing in addition to functioning as the heater at the partial region of the holder 140. Specifically, an inner side surface of the holder 140 facing the accommodation space 141 is made of a material to be heated through the induction heating, and a heat insulation structure is formed between the inner side surface and an outer side surface. Thus, in the inhaler device 100, the heater that heats the stick substrate 150 from the outer circumference and the heat insulation structure that suppresses heat transfer from the heater can be obtained by the holder 140. This can reduce the size of the entire device.

Furthermore, in the inhaler device 100 according to the present embodiment, a temperature detector is provided in the heat insulation structure at the position corresponding to the partial region of the holder 140 functioning as the heater. Thus, the inhaler device 100 can directly measure the temperature of the heater by the temperature detector without being affected by a heat insulation function of the heat insulation structure.

### (2) Configuration of Holder

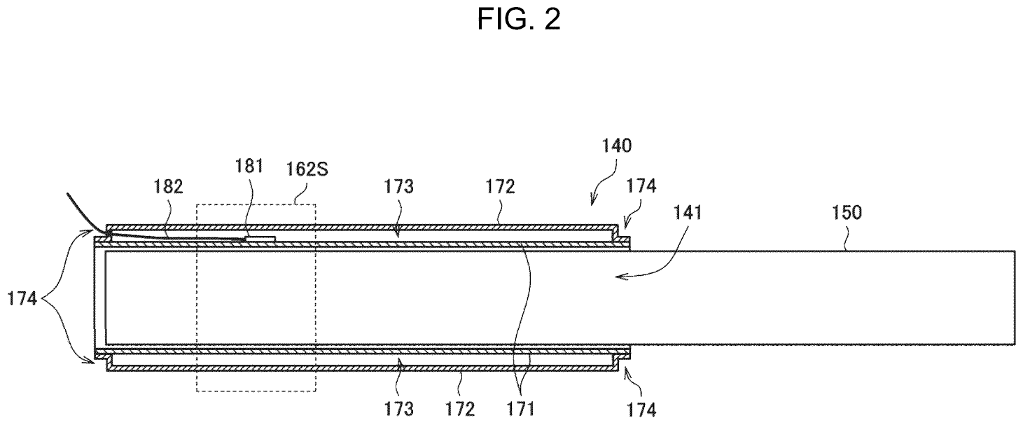

Next, the holder 140 included in the inhaler device 100 according to the present embodiment is described in more detail with reference to FIG. 2. FIG. 2 is a schematic sectional view illustrating a configuration of the holder 140 included in the inhaler device 100.

As illustrated in FIG. 2, the holder 140 includes a first member 171, a second member 172, and a temperature detector 181.

The first member 171 has a tubular structure facing, at an inner side surface thereof, the accommodation space 141 to accommodate the stick substrate 150. The first member 171 is made of a material that can be heated through the induction heating caused by the varying magnetic field. Thus, the first member 171 functions as a susceptor that heats the stick substrate 150. For example, the first member 171 may be made of a ferromagnetic material such as iron, nickel, or cobalt that is comparatively easily to be heated through the induction heating or may be made of an alloy or a chemical compound mainly including the above-described ferromagnetic material.

The second member 172 has a tubular structure covering the first member 171 and forms a sealed space 173 between an outer side surface of the first member 171 and the second member 172. The inside of the sealed space 173 may be, for example, a vacuum space of lower than or equal to 10⁻² Pa. Thus, the holder 140 can suppress heat transfer from the first member 171 to the second member 172 due to vacuum insulation of the sealed space 173. The second member 172 may be made of any material that can be joined to the first member 171 and may be made of a different material from the material of the first member 171.

The sealed space 173 can be formed when the first member 171 and the second member 172 are joined to each other at joints 174 at both end portions of each of the tubular structures. Specifically, at the joints 174, each end portion of the tubular structure of the second member 172 is bent twice so as to form a step toward the outer side surface of the first member 171, and the end portion at a distal end of the formed step is joined to the outer side surface of the first member 171. Thus, the sealed space 173 is formed between the first member 171 and the second member 172 to have a tubular shape so as to cover first member 171. When the first member 171 and the second member 172 are joined so that the step is formed on the second member 172 side, the holder 140 can further improve the degree of contact between the first member 171 serving as the heater and the stick substrate 150.

Such joints 174 can be formed by, for example, the following method. First, both the end portions of the tubular structure of the second member 172 are processed so as to form the steps, and then, the first member 171 is inserted into the second member 172 to which an adhesive or a sealant is applied at the steps. Next, one end portions of the first member 171 and the second member 172 to which the adhesive is applied are joined by brazing or the like, and then, the inside of the sealed space 173 is evacuated from the other end portions to which the sealant is applied. Then, the other end portions to which the sealant is applied are sealed by brazing or the like.

The temperature detector 181 is provided in the sealed space 173 between the first member 171 and the second member 172 so as to correspond to a heat production region 162S of the first member 171 that is heated through the induction heating.

In the heat production region 162S, the varying magnetic field generated by the electromagnetic induction source 162 overlaps the first member 171. When the first member 171 overlapped by the varying magnetic field is heated through the induction heating, the stick substrate 150 facing the first member 171 in the heat production region 162S can be heated. For example, when the electromagnetic induction source 162 is an induction coil, the heat production region 162S may be a region where an outer circumference of the holder 140 is covered with the induction coil serving as the electromagnetic induction source 162.

The temperature detector 181 is provided by being pasted on the outer side surface of the first member 171 in the sealed space 173 in the heat production region 162S. Thus, the temperature detector 181 can directly measure the temperature of the first member 171 heated through the induction heating. Accordingly, the temperature detector 181 can measure the temperature of the first member 171 heated through the induction heating with higher accuracy compared to the case where the temperature of the first member 171 is measured in a region deviated from the heat production region 162S or the temperature of the first member 171 is remotely measured from radiated infrared rays.

The temperature detector 181 may include, for example, a thermocouple as the temperature sensor. The thermocouple is a temperature sensor that measures a temperature difference based on a thermoelectromotive force generated at a joint between two types of metal. When the thermocouple is pasted, with a thermosetting adhesive, on the outer side surface of the first member 171 in the heat production region 162S, the temperature of the first member 171 can be measured.

Data such as the temperature measured with the temperature detector 181 may be output to the outside of the sealed space 173 via a heat-resistant cable 182. The heat-resistant cable 182 has a heat resistance of, for example, equal to or higher than 500° C. and extends from the temperature detector 181 to an upstream side so as to be led to the outside of the sealed space 173. The upstream side refers to an upstream side of the air flow that flows through the accommodation space 141 and conveys the aerosol generated from the stick substrate 150. That is, the bottom 143 side of the holder 140 is the upstream side. An opening for leading the heat-resistant cable 182 from the sealed space 173 to the outside may be sealed by, for example, brazing or the like.

With the above-described configuration, even when the heat transfer to the housing is suppressed by vacuum insulation by the sealed space 173, the inhaler device 100 according to the present embodiment can measure the temperature of the first member 171 in the heat production region 162S with the temperature detector 181 directly in contact with the first member 171. This allows the inhaler device 100 to measure the temperature of the first member 171 in the heat production region 162S heated through the induction heating with higher accuracy, and accordingly, the inhaler device 100 can more efficiently heat the stick substrate 150.

### (3) Modification

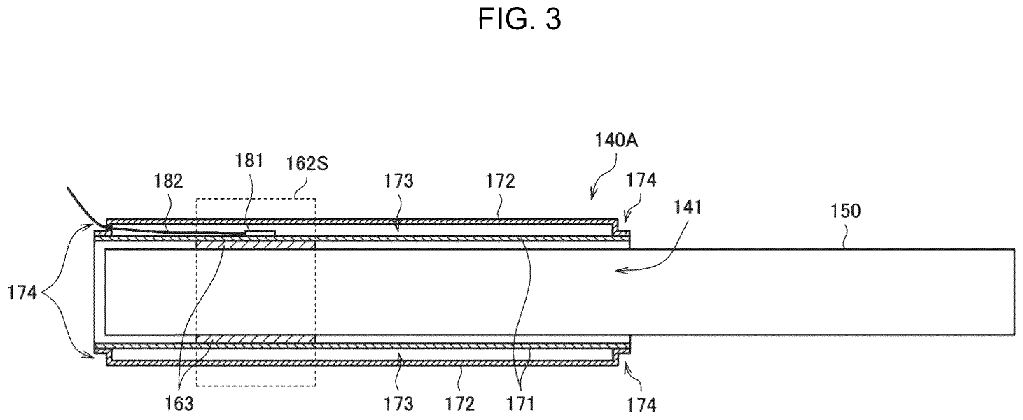

Next, a modification of the inhaler device 100 according to the present embodiment is described with reference to FIG. 3. FIG. 3 is a schematic sectional view illustrating a configuration of a holder 140A according to the modification.

As illustrated in FIG. 3, the holder 140A includes the first member 171, the second member 172, a heater 163, and the temperature detector 181. Unlike the holder 140 illustrated in FIG. 2, in the holder 140A, the first member 171 is not heated through the induction heating, and the heater 163 is additionally provided on the inner side surface of the first member 171.

The first member 171 has a tubular structure facing, at the inner side surface thereof, the accommodation space 141 to accommodate the stick substrate 150. The second member 172 has a tubular structure covering the first member 171 and forms the sealed space 173 between the outer side surface of the first member 171 and the second member 172. The inside of the sealed space 173 may be, for example, a vacuum space of lower than or equal to 10⁻² Pa. Thus, the holder 140 can suppress the heat transfer from the accommodation space 141 to the second member 172 due to vacuum insulation of the sealed space 173. The first member 171 and the second member 172 may be made of metal or glass that are easily joined to each other.

The sealed space 173 can be formed when the first member 171 and the second member 172 are joined to each other at the joints 174 at both the end portions of each of the tubular structures. Specifically, at the joints 174, each end portion of the tubular structure of the second member 172 is bent twice so as to form the step toward the outer side surface of the first member 171, and the end portion at the distal end of the formed step is joined to the outer side surface of the first member 171. Thus, the sealed space 173 is formed between the first member 171 and the second member 172 to have a tubular shape so as to cover first member 171.

The heater 163 is a resistance heater pasted along the inner side surface of the first member 171. Specifically, the heater 163 may be a film heater in which wiring that performs resistance heating is interposed between insulation films. The heater 163 is pasted along the inner side surface of the first member 171 in the heat production region 162S corresponding to a region of the stick substrate 150 filled with the aerosol source.

The temperature detector 181 is provided in the sealed space 173 between the first member 171 and the second member 172 so as to correspond to the heat production region 162S where the heater 163 is provided. The temperature detector 181 may include, for example, a thermocouple as the temperature sensor. The temperature detector 181 is pasted, with the thermosetting adhesive or the like, on the outer side surface of the first member 171 in the sealed space 173 in the heat production region 162S. Thus, the temperature detector 181 can measure the temperature of the heater 163 via the first member 171.

Here, the temperature of the heater 163 can be estimated from an electric resistance of resistance heating wiring included in the film heater. Meanwhile, in the holder 140A according to the modification, the temperature of the heater 163 can be measured with the temperature detector 181. Thus, the temperature of the heater 163 can be measured with higher accuracy. Furthermore, the holder 140A according to the modification includes a plurality of means for measuring the temperature of the heater 163. Accordingly, even when an error occurs in one of the means for measuring the temperature, the temperature of the heater 163 can be measured with the other means for measuring the temperature.

The data such as the temperature measured with the temperature detector 181 may be output to the outside of the sealed space 173 via the heat-resistant cable 182. The heat-resistant cable 182 has a heat resistance of, for example, equal to or higher than 500° C. and extends from the temperature detector 181 to the upstream side so as to be led to the outside of the sealed space 173. An opening for leading the heat-resistant cable 182 from the sealed space 173 to the outside may be sealed by, for example, brazing or the like.

Although the preferred embodiment of the present invention has been described above in detail with reference to the accompanying drawings, the present invention is not limited to such an example. It is apparent that a person having common knowledge in the technical field to which the present invention pertains can make a variety of changes and modifications within the technical ideas described in the claims, and, of course, it is to be understood that these changes and modifications are included within the technical scope of the present invention.

The following configuration is also included in the technical scope of the present invention.

(1)

An aerosol generation device includes
an accommodation space to accommodate an aerosol source material,
a heat insulation structure that has a tubular structure and faces the accommodation space at an inner side surface of the tubular structure thereof,
a heater provided in part of the inner side surface of the heat insulation structure, and
a temperature detector provided in the heat insulation structure so as to correspond to the heater.

(2)

In the aerosol generation device according to (1) described above,
the heater produces heat through induction heating caused by a varying magnetic field, and
the temperature detector is provided so as to correspond to an electromagnetic induction source generating the varying magnetic field.

(3)

In the aerosol generation device according to (1) or (2) described above,
the heat insulation structure includes a first member that faces the accommodation space and a second member that covers an outer side surface of the first member and forms a sealed space between the first member and the second member.

(4)

In the aerosol generation device according to (3) described above,
a material of the first member and a material of the second member are different from each other.

(5)

In the aerosol generation device according to (3) or (4) described above,
the first member and the second member are joined to each other by brazing.

(6)

In the aerosol generation device according to any one of (3) to (5) described above,
the temperature detector is provided in the sealed space of the heat insulation structure.

(7)

In the aerosol generation device according to any one of (3) to (6) described above,
an inside of the sealed space is in a vacuum state.

(8)

In the aerosol generation device according to any one of (3) to (7) described above,
a part of the first member produces heat through the induction heating so as to function as the heater.

(9)

In the aerosol generation device according to (8) described above,
the temperature detector is secured, with a thermosetting adhesive, to the first member functioning as the heater.

(10)

In the aerosol generation device according to (9) described above,
the temperature detector detects a temperature of the heater.

(11)

In the aerosol generation device according to any one of (1) to (10) described above,
the temperature detector includes a thermocouple.

(12)

In the aerosol generation device according to (11) described above,
an air flow conveying an aerosol generated from the aerosol source material flows through the accommodation space, and
a heat-resistant cable that extends to an upstream side of the air flow so as to be led to an outside of the heat insulation structure is connected to the thermocouple.

### REFERENCE SIGNS LIST

100 inhaler device
111 power supply
112 sensor
113 notifier
114 memory
115 communicator
116 controller
140, 140A holder
141 accommodation space
142 opening
143 bottom
150 stick substrate
162 electromagnetic induction source
162S heat production region
163 heater
171 first member
172 second member
173 sealed space
174 joint
181 temperature detector
182 heat-resistant cable

1. An aerosol generation device comprising:
an accommodation space to accommodate an aerosol source material;
a heat insulation structure having a tubular structure, the heat insulation structure facing the accommodation space at an inner side surface of the tubular structure thereof;
a heater provided in part of the inner side surface of the heat insulation structure; and
a temperature detector provided in the heat insulation structure so as to correspond to the heater.

2. The aerosol generation device according to claim 1,
wherein the heater produces heat through induction heating caused by a varying magnetic field, and
wherein the temperature detector is provided so as to correspond to an electromagnetic induction source generating the varying magnetic field.

3. The aerosol generation device according to claim 1,
wherein the heat insulation structure includes a first member facing the accommodation space and a second member covering an outer side surface of the first member, the second member forming a sealed space between the first member and the second member.

4. The aerosol generation device according to claim 3,
wherein a material of the first member and a material of the second member are different from each other.

5. The aerosol generation device according to claim 3,
wherein the first member and the second member are joined to each other by brazing.

6. The aerosol generation device according to claim 3,
wherein the temperature detector is provided in the sealed space of the heat insulation structure.

7. The aerosol generation device according to claim 3,
wherein an inside of the sealed space is in a vacuum state.

8. The aerosol generation device according to claim 3,
wherein a part of the first member produces heat through the induction heating so as to function as the heater.

9. The aerosol generation device according to claim 8,
wherein the temperature detector is secured, with a thermosetting adhesive, to the first member functioning as the heater.

10. The aerosol generation device according to claim 9,
wherein the temperature detector detects a temperature of the heater.

11. The aerosol generation device according to claim 1,
wherein the temperature detector includes a thermocouple.

12. The aerosol generation device according to claim 11,
wherein an air flow conveying an aerosol generated from the aerosol source material flows through the accommodation space, and
wherein a heat-resistant cable that extends to an upstream side of the air flow so as to be led to an outside of the heat insulation structure is connected to the thermocouple.
